(19) United States
(12) Patent Application Publication
(10) Pub. No.: US 2008/0165443 A1
(43) Pub. Date: Jul. 10, 2008

(54) Method and device for compensating for thermal decay in a magnetic storage device

(75) Inventor: Jerry Moline, Denver, CO (US)

Correspondence Address: Westman, Champlin & Kelly, #1400, 900 Second Avenue South, Minneapolis, MN, 55402-3319, US

(73) Assignee: SEAGATE TECHNOLOGY, LLC, Scotts Valley, CA (US)

(21) Appl. No.: 11/651,225

(22) Filed: Jan. 9, 2007

(51) Int. Cl. G11B 5/02

(52) U.S. Cl. 360/25

(57) ABSTRACT

The present disclosure is directed to systems and methods of compensating for thermal decay of a magnetic data storage medium. In a particular embodiment, the method includes reading a calibration track on a magnetic data storage medium to obtain a first measurement of a track characteristic. The method also includes overwriting the calibration track with a first specific data pattern and reading the calibration track to obtain a second measurement of the track characteristic. The method also includes determining whether a thermal decay rate of the calibration track is acceptable based on the first measurement and the second measurement.

### FIELD OF THE DISCLOSURE

The present disclosure relates generally to magnetization and thermal decay. More specifically, the present disclosure relates to compensating for thermal decay of a magnetic data storage medium.

### BACKGROUND

After a magnetic disc is magnetized, the magnetization is dissolved slightly from thermal decay as time passes. With respect to data stored on the magnetic disc for relatively large periods of time, thermal decay of the magnetic disc may eventually result in data loss of an undesirable magnitude. Thermal decay results in a progressive loss of amplitude of recorded data on the magnetic disc.

In a magnetic data storage device, the fly-height, i.e. the distance between the transducing head and the magnetic disc, may be adjusted based on baseline measurement data read from a calibration track on the magnetic disc. Previously, a calibration track was written as soon as possible after the data channel of the magnetic data storage device was optimized and the baseline measurement data was collected at the end of the device testing process. However, this process did not take into account thermal decay that would continue after the test process was complete. Thus, the unaccounted for thermal decay can cause errors in the fly-height adjustment that can result in an increased risk of failure of the magnetic data storage device.

There is a need for a method and device for reducing thermal decay.

### BRIEF DESCRIPTION OF THE DRAWINGS

FIG. 1 is a cutaway view of an illustrative embodiment of a disc drive;

FIG. 2 is a block diagram of an illustrative embodiment of a disc drive system;

FIG. 3 is a general diagram of an illustrative embodiment of data storage elements in a disc drive.

FIG. 4 is a flow diagram of an illustrative embodiment of a method for compensating for thermal decay of a magnetized disc.

### DETAILED DESCRIPTION

In the following detailed description of the embodiments, reference is made to the accompanying drawings which form a part hereof, and in which are shown by way of illustration of specific embodiments. It is to be understood that other embodiments may be utilized and structural changes may be made without departing from the scope of the present invention.

In a particular embodiment, the present disclosure is directed to a method including reading a calibration track on a magnetic data storage medium to obtain a first measurement of a track characteristic. The method also includes overwriting the calibration track with a first specific data pattern and reading the calibration track to obtain a second measurement of the track characteristic. The method also includes determining whether a thermal decay rate of the calibration track is acceptable based on the first measurement and the second measurement.

In another embodiment, the present disclosure is directed to a computer-readable medium having instructions for causing a processor to execute a method including reading a calibration track on a magnetic data storage medium to obtain a first measurement of a track characteristic. The method also includes overwriting the calibration track with a first specific data pattern and reading the calibration track to obtain a second measurement of the track characteristic. Further, the method includes determining whether a thermal decay of the calibration track is acceptable based on the first measurement and the second measurement.

In yet another embodiment, the present disclosure is directed to a device including a magnetic data storage medium. The device also includes a calibration track on the magnetic data storage medium having a first thermal decay rate and a non-calibration track on the magnetic data storage medium having a second thermal decay rate.

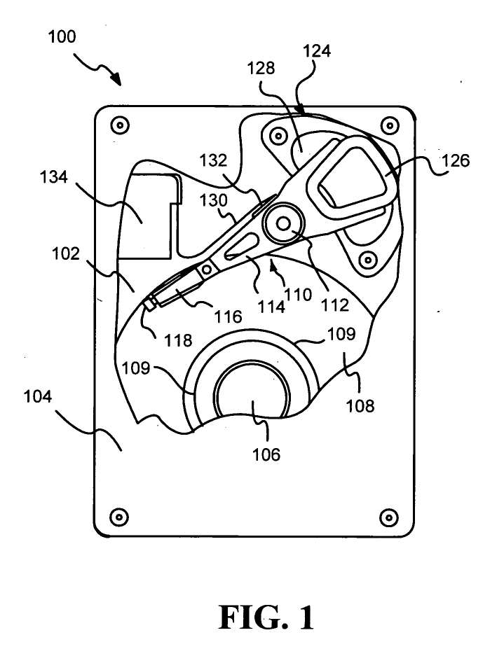

Referring to FIG. 1, in a particular embodiment, a disc drive 100 includes a base 102 to which various components of the disc drive 100 are mounted. A top cover 104, shown partially cut away, cooperates with the base 102 to form an internal, sealed environment for the disc drive. The components of the disc drive 100 include a spindle motor 106, which rotates one or more discs 108. Information is written to and read from tracks on the discs 108 through the use of an actuator assembly 110 that rotate about a bearing shaft assembly 112 positioned adjacent the discs 108. The actuator assembly 110 includes one or more actuator arms 114 that extend toward the discs 108, with one or more flexures 116 extending from the actuator arms 114. Mounted at the distal end of each of the flexures 116 is a head 118 including an air bearing slider (not shown) that enables the head 118 to fly in close proximity above the corresponding surface of the associated disc 108.

The track position of the heads 118 is controlled, during a seek operation, through the use of a voice coil motor (VCM) 124 that typically includes a coil 126 attached to the actuator assembly 110, as well as one or more permanent magnets 128 that establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

A flex assembly 130 provides requisite electrical connection paths for the actuator assembly 110 while allowing pivotal movement of the actuator assembly 110 during operation. The flex assembly 130 can include a printed circuit board 132 to which head wires (not shown) are connected. The head wires may be routed along the actuator arms 114 and the flexures 116 to the heads 118. The printed circuit board 132 may include circuitry for controlling the write currents applied to the heads 118 during a write operation and a preamplifier (not shown) for amplifying read signals generated by the heads 118 during a read operation. The flex assembly 130 terminates at a flex bracket 134 for communication through the base 102 to a disc drive printed circuit board (not shown) mounted to the disc drive 100.

As shown in FIG. 1, a plurality of nominally circular, concentric tracks 109 are located on the surface of the discs 108. Each track 109 includes a number of servo fields that are interspersed with user data fields along the track 109. The user data fields are used to store user data, and the servo fields are used to store servo information used by a disc drive servo system to control the position of the heads 118.

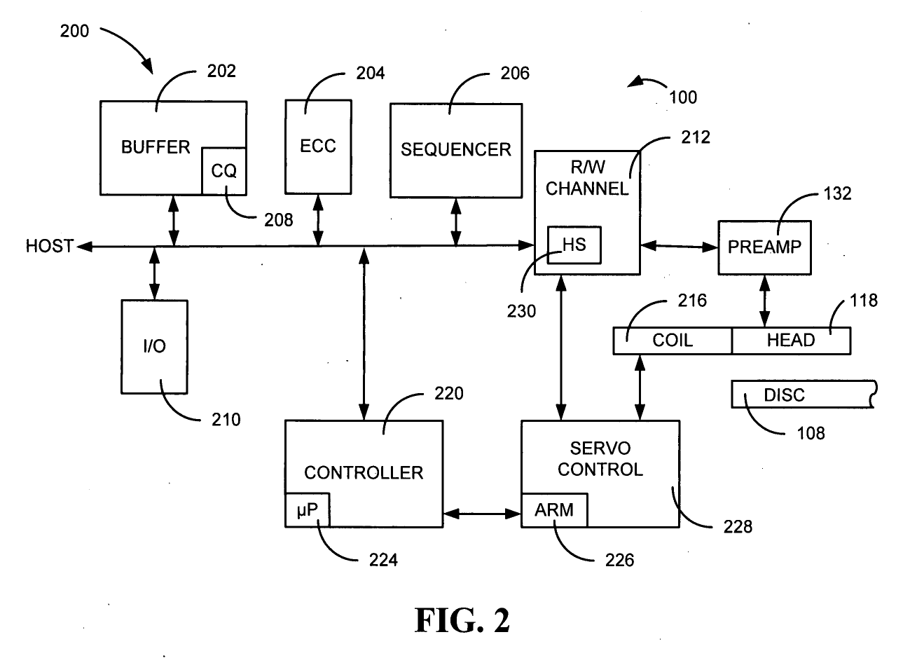

FIG. 2 provides a functional block diagram of the disc drive 100. A hardware/firmware based interface circuit 200 communicates with a host device (such as a personal computer, not shown) and directs overall disc drive operation. The interface circuit 200 includes a programmable controller 220 with associated microprocessor 224. The interface circuit 200 also includes a buffer 202, an error correction code (ECC) block 204, a sequencer 206, and an input/output (I/O) control block 210.

The buffer 202 temporarily stores user data during read and write operations, and includes a command queue (CQ) 208 where multiple pending access operations are temporarily stored pending execution. The ECC block 204 applies on-the-fly error detection and correction to retrieved data. The sequencer 206 asserts read and write gates to direct the reading and writing of data. The I/O block 210 serves as an interface with the host device.

FIG. 2 further shows the disc drive 100 to include a read/write (R/W) channel 212 which encodes data during write operations and reconstructs user data retrieved from the discs 108 during read operations. The R/W channel 212 also includes a harmonic sensor 230 for performing spectral analysis of R/W signals. The harmonic sensor 230 enables measurement of harmonic components of R/W signals. A preamplifier/driver circuit (preamp) 132 applies write currents to the heads 118 and provides pre-amplification of readback signals.

A servo control circuit 228 uses servo data to provide the appropriate current to the coil 216 to position the heads 118. The controller 220 communicates with a processor 226 to move the heads 118 to the desired locations on the disc 108 during execution of the various pending commands in the command queue 208.

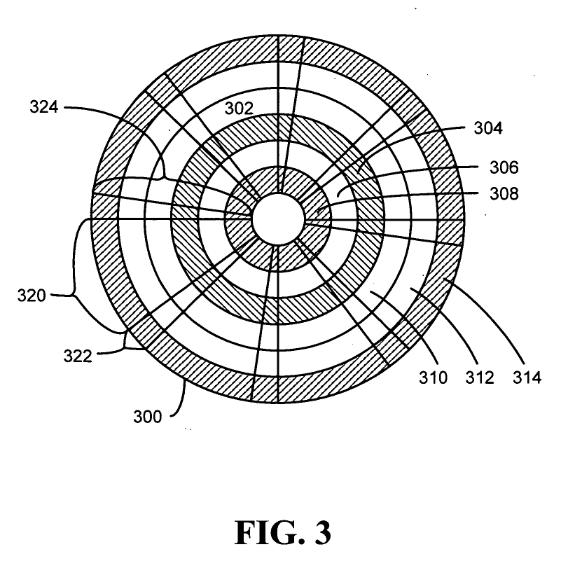

FIG. 3 is a diagrammatic representation of a simplified top view of a disc 300 having a surface 302. As illustrated in FIG. 3, the disc 300 includes a plurality of concentric tracks 304, 306, 308, 310, 312, and 314 for storing data on the surface 302. Although FIG. 3 only shows a relatively small number of tracks (i.e., 6) for ease of illustration, it should be appreciated that typically tens of thousands of tracks are included on the surface 302 of the disc 300.

Each track 304, 306, 308, 310, 312, and 314 is divided into a plurality of data sectors 320 and a plurality of servo sectors 322. The servo sectors 322 in each track are radially aligned with servo sectors 322 in the other tracks, thereby forming servo wedges 324 which extend radially across the disc 300.

In a particular embodiment, the track 314 is a calibration track located at an outer diameter of the disc 300. In another particular embodiment, the track 308 is a calibration track located at the inner diameter of the disc. In yet another, particular embodiment, a calibration track is located anywhere on the surface 302 of the disc 300, such as at track 304. In yet another embodiment, there is more than one calibration track on the surface 302. A calibration track can be used by a disc drive, such as disc drive 100, to determine certain operating characteristics of the disc drive.

In a particular embodiment, the disc drive 100 uses a harmonic sensor, such as harmonic sensor 230, to determine fly-height adjustments, i.e. adjustments to the spacing between the head 118 and the disc 108. The harmonic sensor reads an Equivalent Nanometer (EQNM) measurement from a calibration track, such as calibration track 314. In a particular embodiment an EQNM measurement is calculated by sampling a track, such as calibration track 314, with a 6T pattern written on it and calculating a ratio of a first harmonic and a third harmonic of the 6T pattern. The disc drive 100 then processes the EQNM measurement to determine an error in the fly-height. Errors in the fly-height can be due to environmental changes such as altitude changes or temperature changes.

In another particular embodiment, a harmonic sensor 230 samples a calibration track, such as calibration track 314, and calculates a ratio of a first harmonic and a third harmonic of a 6T pattern (i.e., repetitively occurring sets of six +1 bits followed by six −1 bits) written on the calibration track. The ratio will change as the fly-height changes. This measurement and calculation returns a number in nanometers (nM) that is compared to a baseline measurement taken during a testing process. A difference between the baseline measurement and the current measurement is the change in fly height. If the difference exceeds a predetermined threshold, a correction to the fly-height is applied.

In a particular embodiment, the calibration track 314 is written during a manufacturing test process of the disc drive. In another particular embodiment, the calibration track 314 is written during field use of the disc drive.

If the characteristics of the calibration track change due to thermal decay, a measurement, such as the EQNM measurement, may have errors. Therefore, any adjustments to the drive, such as the fly-height adjustments, may also contain errors and cause the disc drive to fail. For example, if the EQNM measurement is wrong, then the drive may provide a wrong adjustment for the fly-height and cause the head to contact the disc, which may lead to failure of the disc drive.

In a particular embodiment, thermal decay will lead to an EQNM measurement that is a higher value than expected and will therefore cause the heads, such as heads 118, to be adjusted closer to the disc, such as disc 108, than desired. This may cause the head to contact the disc and may lead to failure of the disc drive. If the thermal decay occurs over time, the incorrect EQNM measurement will cause the head 118 to fly closer to the disc 108 over time and may cause the head to contact (i.e. crash) the disc before the useful life of drive is complete.

In a particular embodiment, the calibration track, such as track 314, is written during a manufacturing process with a DC pattern until the EQNM measurement is acceptable. This will result in a calibration track that does not have significant effective thermal decay. Thus, the calibration track will not add as much error to the EQNM measurement. In a particular embodiment, the calibration track 314 has a different thermal decay than a non-calibration track, such as track 310 or 312. A thermal decay rate can be measured by sampling the track periodically over a period of time while maintaining constant temperature and atmospheric pressure; the error rate remains constant allowing the measurement of the thermal decay rate over a period of time (i.e. one or two weeks) to predict a long term thermal decay rate.

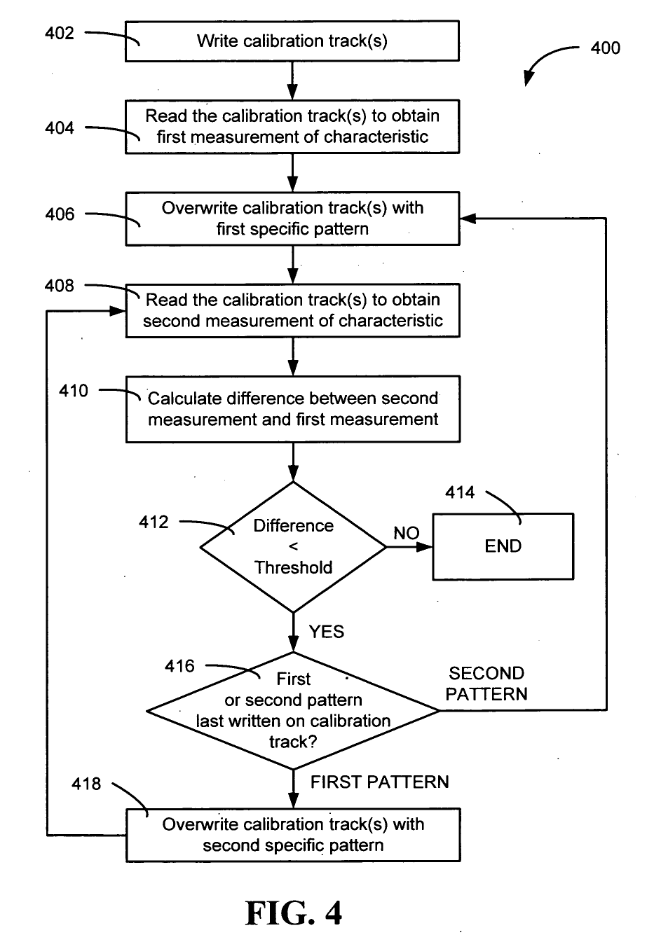

FIG. 4 provides a flow diagram of an illustrative embodiment of a method 400 for compensating for thermal decay of a magnetized disc, such as disc 300. At least one calibration track is written, at 402. In a particular embodiment, more than one calibration track is written, at 402. The calibration tracks are read to determine a first measurement of a characteristic of the calibration tracks, at 404. In a particular embodiment, a harmonic sensor, such as harmonic sensor 230, reads an equivalent nanometer measurement (EQNM) from the calibration track. In a particular embodiment an EQNM measurement is calculated by sampling a track, such as calibration track 314, with a 6T pattern written on it and calculating a ratio of a first harmonic and a third harmonic of the 6T pattern. In a particular embodiment, the result of the first measurement is stored in a buffer or memory.

The calibration tracks are overwritten with a first specific pattern, at 406. In a particular embodiment, the calibration tracks are overwritten with pattern 00 (+DC) using a direct write mode that uses a minimum write current and no fly height actuation, i.e. the direct write occurs at the maximum fly height.

The calibration tracks are read to determine a second measurement of a characteristic of the calibration tracks, at 408. In a particular embodiment, a harmonic sensor, such as harmonic sensor 230, reads an EQNM measurement from the calibration track. In a particular embodiment, the result of the second measurement is stored in a buffer or memory.

A difference between the second measurement and the first measurement is calculated, at 410. The difference is compared to a threshold, at 412. The threshold may be chosen to provide low thermal decay over a specified period of time.

When the difference is less than the threshold, whether the first specific pattern or a second specific pattern was last written is determined, at 416. When the first specific pattern was last written, the calibration tracks are overwritten with the second specific pattern, at 418. In a particular embodiment, the second specific pattern is pattern ff (−DC) using a direct write mode that uses a minimum write current and no fly height actuation.

After the second specific pattern is written, the calibration tracks are read to determine another measurement of a characteristic of the calibration tracks, at 408. In a particular embodiment, a harmonic sensor, such as harmonic sensor 230, reads an EQNM MEASUREMENT from the calibration track. A difference between the last measurement and the first measurement is calculated, at 410. The difference is compared to the threshold, at 412.

When the difference is less than the threshold, whether the first specific pattern or a second specific pattern was last written is determined, at 416. When the second specific pattern was last written, the calibration tracks are overwritten with the first specific pattern, at 406.

The method 400 repeats writing the calibration track while alternating between writing the first specific pattern and writing the second specific pattern. The calibration track is written with one of the patterns until the difference between the last measurement and the first measurement is greater than or equal to the threshold, at 414.

In a particular embodiment, the method 400 is performed during a testing phase of a disc drive manufacturing process. The method 400 accelerates the effective thermal decay before collecting baseline measurement data by overwriting the calibration tracks with a DC pattern until the EQNM measurement has increased by a predetermined threshold amount. This will provide a stable calibration track that will not have significant effective thermal decay that adds error to the EQNM measurement.

In a particular embodiment, the pattern 00 and the pattern ff are patterns loaded into a write buffer and written to a track with the encoder turned off. The result is a DC write. The difference between the two patterns is the polarity of the DC. Using alternate polarity in the conditioning DC writes should provide equal conditioning to positive and negative transitions.

Alternatively, the method 400 could be used for any calibration track where thermal decay over the life of the drive is an issue. In a particular embodiment, the resulting thermal decay of the calibration tracks should be such that the error in the resulting EQNM measurement over the life of the drive is less than the target fly height.

The method 400 allows the sampling of harmonic sensor data to be more consistent and will allow better fly-height control over the life of the drive. Alternatively, the method 400 allows for sampling of the calibration tracks by any other method to be more consistent.

In accordance with various embodiments, the methods described herein may be implemented as one or more software programs running on a computer processor or controller, such as the controller 220. In accordance with another embodiment, the methods described herein may be implemented as one or more software programs running on a host device, such as a PC that is using a disc drive. Dedicated hardware implementations including, but not limited to, application specific integrated circuits, programmable logic arrays and other hardware devices can likewise be constructed to implement the methods described herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
reading a calibration track on a magnetic data storage medium to obtain a first measurement of a track characteristic;
overwriting the calibration track with a first specific data pattern;
reading the calibration track to obtain a second measurement of the track characteristic; and
determining whether a thermal decay rate of the calibration track is acceptable based on the first measurement and the second measurement.

2. The method of claim 1 further comprising:
calculating a first value based on the second measurement and the first measurement;
comparing the first value to a threshold; and
determining whether a thermal decay rate of the calibration track is acceptable based on the comparing the first value to the threshold.

3. The method of claim 2 further comprising calculating the value from a difference between the second measurement and the first measurement.

4. The method of claim 2 further comprising:
overwriting the calibration track with a second specific pattern;
reading the calibration track to obtain a third measurement of the track characteristic;
calculating a second value based on the third measurement and the first measurement;
comparing the second value to the threshold;
determining whether a thermal decay of the calibration track is acceptable based on the comparing the second value to the threshold.

5. The method of claim 4 further comprising repeating the method until the thermal decay is determined to be acceptable.

6. The method of claim 4, wherein the first specific pattern is a 00 (+DC) pattern.

7. The method of claim 6, wherein the second specific pattern is a ff (−DC) pattern.

8. The method of claim 1, wherein an adjustment to a distance between a transducer and the magnetic data storage medium is based on a measurement from the calibration track.

9. The method of claim 1, wherein the first pattern is written at a maximum fly height of a transducer.

10. The method of claim 9, wherein the first pattern is written at a minimum write current.

11. A device comprising:
a magnetic data storage medium;
a calibration track on the magnetic data storage medium having a first compensated thermal decay rate;
non-calibration tracks on the magnetic data storage medium having a second thermal decay rate; and
wherein the first thermal decay rate is less than the second thermal decay rate.

12. The device of claim 11, wherein the calibration track has the first thermal decay rate after application of a calibration track adjustment pattern.

13. The device of claim 11, wherein the calibration track is located on an inner diameter track of the magnetic data storage medium, on an outer diameter track of the magnetic data storage medium, or on both the inner diameter track and the outer diameter track.

14. The device of claim 11, wherein the calibration track is at a location between an inner diameter track of the magnetic data storage device and an outer diameter track of the magnetic data storage device.

15. The device of claim 111 further comprising:
a transducer for reading data from and writing data to the magnetic data storage medium; and
a processor operably programmed to:
read the calibration track to obtain a first measurement of a track characteristic;
overwrite the calibration track with a first specific data pattern;
read the calibration track to obtain a second measurement of the track characteristic;
calculate a first value based on the second measurement and the first measurement;
compare the first value to a threshold;
determine whether a thermal decay of the calibration track is acceptable based on the comparing the first value to a threshold.

16. The device of claim 15 wherein the processor is further operably programmed to:
overwrite the calibration track with a second specific pattern;
read the calibration track to obtain a third measurement of the track characteristic;
calculate a second value based on the third measurement and the first measurement;
compare the second value to the threshold;
determine whether a thermal decay of the calibration track is acceptable based on the comparing.

17. A computer-readable medium having instructions for causing a processor to execute a method comprising:
reading a calibration track on a magnetic data storage medium to obtain a first measurement of a track characteristic;
overwriting the calibration track with a first specific data pattern;
reading the calibration track to obtain a second measurement of the track characteristic;
determining whether a thermal decay of the calibration track is acceptable based on the first measurement and the second measurement.

18. The computer-readable medium of claim 17 having instructions for causing a processor to execute a method further comprising:
calculating a first value based on the second measurement and the first measurement;
comparing the first value to a threshold; and
determining whether a thermal decay rate of the calibration track is acceptable based on the comparing the first value to the threshold.

19. The computer-readable medium of claim 18 having instructions for causing a processor to execute a method further comprising:
overwriting the calibration track with a second specific pattern;
reading the calibration track to obtain a third measurement of the track characteristic;
calculating a second value based on the third measurement and the first measurement;
comparing the second value to the threshold;
determining whether a thermal decay of the calibration track is acceptable based on the comparing the second value to the threshold.

20. The computer readable medium of claim 19, wherein a transducer fly-height adjustment is determined based on the calibration track.
